(19) United States
(12) Patent Application Publication
(10) Pub. No.: US 2013/0202286 A1
(43) Pub. Date: Aug. 8, 2013

(54) Ethernet Passive Optical Network Over Coaxial (EPOC) Protection Switching

(71) Applicants: Edward Wayne Boyd, Petaluma, CA (US); Sanjay Goswami, Santa Rosa, CA (US)

(72) Inventors: Edward Wayne Boyd, Petaluma, CA (US); Sanjay Goswami, Santa Rosa, CA (US)

(73) Assignee: Broadcom Corporation, Irvine, CA (US)

(21) Appl. No.: 13/432,579

(22) Filed: Mar. 28, 2012

Related U.S. Application Data
(60) Provisional application No. 61/594,788, filed on Feb. 3, 2012.

(51) Int. Cl. H04B 10/14

(52) U.S. Cl. 398/5

(57) ABSTRACT

Protection switching methods, systems, and architectures are provided for hybrid Ethernet Passive Optical Network (EPON)-Ethernet Passive Optical Network Over Coaxial (EPOC) networks. Protection switching embodiments enable protection of the EPON portion and/or the EPOC portion of the hybrid network. In embodiments, protection switching may be initiated by an Optical Line Terminal (OLT), a coaxial media converter (CMC), or an optical network unit (ONU)/coaxial network unit (CNU) in the hybrid network.

### CROSS-REFERENCE TO RELATED APPLICATIONS

The present application claims the benefit of U.S. Provisional Patent Application No. 61/594,788 filed on Feb. 3, 2012, which is incorporated herein by reference in its entirety.

### BACKGROUND

1. Field of the Invention

The present disclosure relates generally to Ethernet.

2. Background Art

A Passive Optical Network (PON) is a single, shared optical fiber that uses inexpensive optical splitters to divide a single fiber into separate strands feeding individual subscribers. An Ethernet PON (EPON) is a PON based on the Ethernet standard. EPONs provide simple, easy-to-manage connectivity to Ethernet-based, IP equipment, both at customer premises and at the central office. As with other Gigabit Ethernet media, EPONs are well-suited to carry packetized traffic. An Ethernet Passive Optical Network Over Coax (EPOC) is a network that enables EPON connectivity over a coaxial network.

### BRIEF DESCRIPTION OF THE DRAWINGS/FIGURES

The accompanying drawings, which are incorporated herein and form a part of the specification, illustrate the present disclosure and, together with the description, further serve to explain the principles of the disclosure and to enable a person skilled in the pertinent art to make and use the disclosure.

FIG. 1 illustrates an example hybrid Ethernet Passive Optical Network (EPON)-Ethernet Passive Optical Network Over Coax (EPOC) network architecture.

FIG. 2 illustrates another example hybrid EPON-EPOC network architecture.

FIG. 3 illustrates an example EPOC portion of a hybrid EPON-EPOC network according to an embodiment of the present disclosure.

FIG. 4 illustrates an example architecture with EPOC protection switching according to an embodiment of the present disclosure.

FIG. 5 illustrates another example architecture with EPOC protection switching according to an embodiment of the present disclosure.

FIG. 6 illustrates another example architecture with EPOC protection switching according to an embodiment of the present disclosure.

FIG. 7 is a process flowchart of a method for providing protection switching in an EPOC according to an embodiment of the present disclosure.

FIG. 8 is a process flowchart of a method for providing protection switching in an EPOC according to an embodiment of the present disclosure.

FIG. 9 illustrates an example computer system that can be used to implement aspects of the present disclosure.

The present disclosure will be described with reference to the accompanying drawings. Generally, the drawing in which an element first appears is typically indicated by the leftmost digit(s) in the corresponding reference number.

### DETAILED DESCRIPTION OF EMBODIMENTS

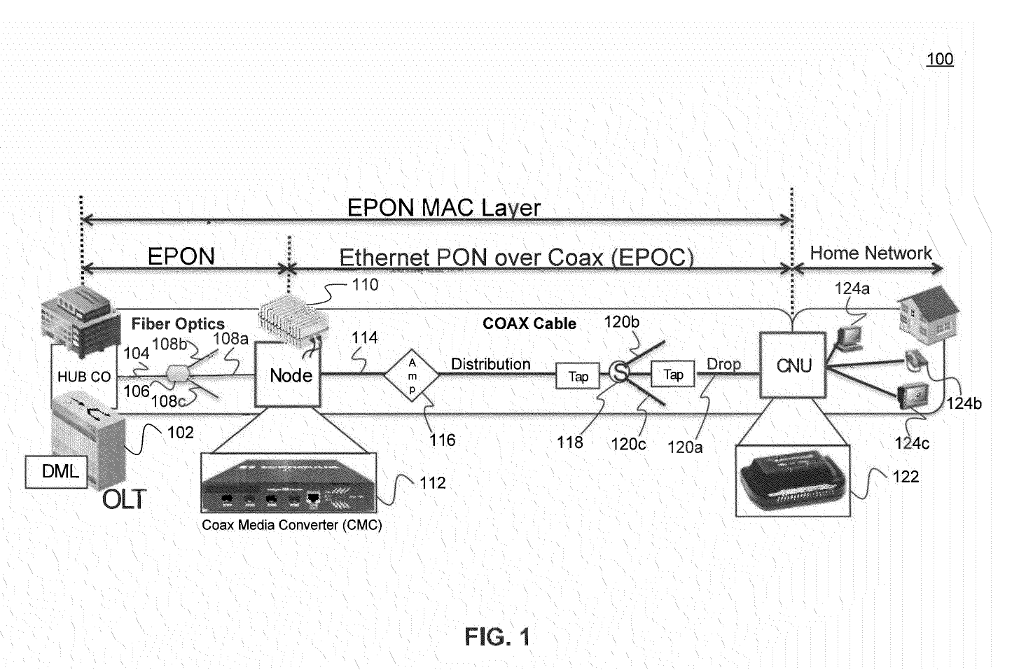

FIG. 1 illustrates an example hybrid Ethernet Passive Optical Network (EPON)-Ethernet Passive Optical Network Over Coax (EPOC) network architecture 100 according to an embodiment of the present disclosure. As shown in FIG. 1, example network architecture 100 includes an Optical Line Terminal (OLT) 102, an optional optical passive splitter 106, a communications node 110 including a coaxial media converter (CMC), an optional amplifier 116, an optional coaxial splitter 118, a coaxial network unit (CNU) 122, and a plurality of subscriber media devices 124.

OLT 102 sits at a central office (CO) of the network and is coupled to a fiber optic line 104. OLT 102 may implement a DOCSIS (Data Over Cable Service Interface Specification) Mediation Layer (DML) which allows OLT 102 to provide DOCSIS provisioning and management of network components (e.g., CMC, CMU, Optical Network Unit (ONU)). Additionally, OLT 102 implements an EPON Media Access Control (MAC) layer (e.g., IEEE 802.3ah).

Optionally, passive splitter 106 can be used to split fiber optic line 104 into a plurality of fiber optic lines 108. This allows multiple subscribers in different geographical areas to be served by the same OLT 102 in a point-to-multipoint topology.

Communications node 110 serves as a converter between the EPON side and the EPOC side of the network. Accordingly, node 110 is coupled from the EPON side of the network to a fiber optic line 108a, and from the EPOC side of the network to a coaxial cable 114. In an embodiment, communications node 110 includes a coaxial media converter (CMC) 112 that allows EPON to EPOC (and vice versa) conversion.

CMC 112 performs physical layer (PHY) conversion from EPON to EPOC, and vice versa. In an embodiment, CMC 112 includes a first interface (not shown in FIG. 1), coupled to fiber optic line 108, configured to receive a first optical signal from OLT 102 and generate a first bitstream having a first physical layer (PHY) encoding. In an embodiment, the first PHY encoding is EPON PHY encoding. CMC 112 also includes a PHY conversion module (not shown in FIG. 1), coupled to the first interface, configured to perform PHY layer conversion of the first bitstream to generate a second bitstream having a second PHY encoding. In an embodiment, the second PHY encoding is EPOC PHY encoding. Furthermore, CMC 112 includes a second interface (not shown in FIG. 1), coupled to the PHY conversion module and to coaxial cable 114, configured to generate a first radio frequency (RF) signal from the second bitstream and to transmit the first RF signal over coaxial cable 114.

In EPOC to EPON conversion (i.e., in upstream communication), the second interface of CMC 112 is configured to receive a second RF signal from CNU 122 and generate a third bitstream therefrom having the second PHY encoding (e.g., EPOC PHY encoding). The PHY conversion module of CMC 112 is configured to perform PHY layer conversion of the third bitstream to generate a fourth bitstream having the first PHY encoding (e.g., EPON PHY encoding). Subsequently, the first interface of CMC 112 is configured to generate a second optical signal from the fourth bitstream and to transmit the second optical signal to OLT 102 over fiber optic line 108.

Optionally, an amplifier 116 and a second splitter 118 can be placed in the path between communications node 110 and CNU 122. Amplifier 116 amplifies the RF signal over coaxial cable 114 before splitting by second splitter 118. Second splitter 118 splits coaxial cable 114 into a plurality of coaxial cables 120, to allow service over coaxial cables of several subscribers which can be within same or different geographic vicinities.

CNU 122 generally sits at the subscriber end of the network. In an embodiment, CNU 122 implements an EPON MAC layer, and thus terminates an end-to-end EPON MAC link with OLT 102. Accordingly, CMC 112 enables end-to-end provisioning, management, and Quality of Service (QoS) functions between OLT 102 and CNU 122. CNU 122 also provides multiple Ethernet interfaces that could range between 10 Mbps to 10 Gbps, to connect subscriber media devices 124 to the network. Additionally, CNU 122 enables gateway integration for various services, including VOIP (Voice-Over-IP), MoCA (Multimedia over Coax Alliance), HPNA (Home Phoneline Networking Alliance), Wi-Fi (Wi-Fi Alliance), etc. At the physical layer, CNU 122 may perform physical layer conversion from coaxial to another medium, while retaining the EPON MAC layer.

According to embodiments, EPON-EPOC conversion can occur anywhere in the path between OLT 102 and CNU 122 to provide various service configurations according to the services needed or infrastructure available to the network. For example, CMC 112, instead of being integrated within node 110, can be integrated within OLT 102, within amplifier 116, or in an Optical Network Unit (ONU) located between OLT 102 and CNU 122 (not shown in FIG. 1).

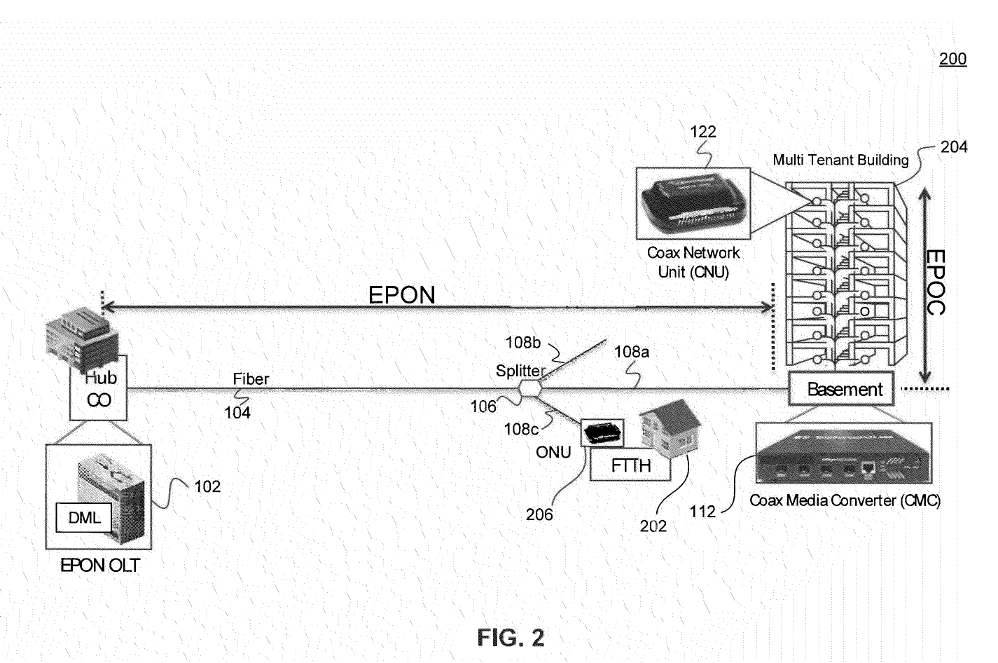

FIG. 2 illustrates another example hybrid EPON-EPOC network architecture 200 according to an embodiment of the present disclosure. In particular, example network architecture 200 enables simultaneous FTTH (Fiber to the Home) and multi-tenant building EPOC service configurations.

Example network architecture 200 includes similar components as described above with reference to example network architecture 100, including an OLT 102 located in a CO hub, a passive splitter 106, a CMC 112, and one or more CNUs 122. OLT 102, splitter 106, CMC 112, and CNU 122 operate in the same manner described above with reference to FIG. 1.

CMC 112 sits, for example, in the basement of a multi-tenant building 204. As such, the EPON side of the network extends as far as possible to the subscriber, with the EPOC side of the network only providing short coaxial connections between CMC 112 and CNU units 122 located in individual apartments of multi-tenant building 204.

Additionally, example network architecture 200 includes an Optical Network Unit (ONU) 206. ONU 206 is coupled to OLT 102 through an all-fiber link, comprised of fiber lines 104 and 108c. ONU 206 enables FTTH service to a home 202, allowing fiber optic line 108c to reach the boundary of the living space of home 202 (e.g., a box on the outside wall of home 202).

Accordingly, example network architecture 200 enables an operator to service both ONUs and CNUs using the same OLT. This includes end-to-end provisioning, management, and QoS with a single interface for both fiber and coaxial subscribers. In addition, example network architecture 200 allows for the elimination of the conventional two-tiered management architecture, which uses media cells at the end user side to manage the subscribers and an OLT to manage the media cells.

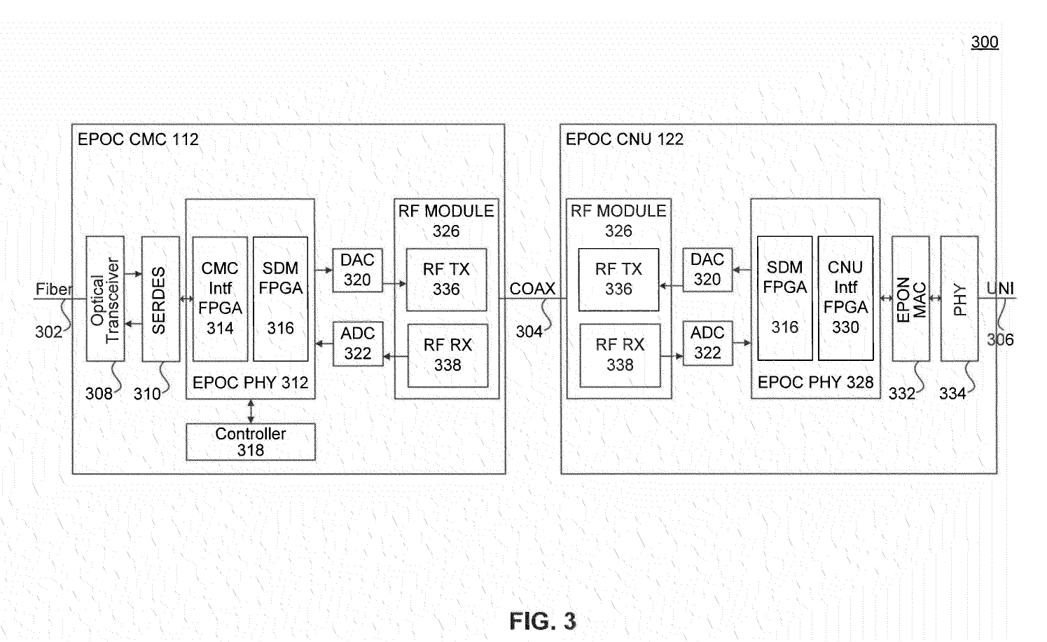

FIG. 3 illustrates an example implementation 300 of an EPOC portion of a hybrid EPON-EPOC network. Example implementation 300 may be an embodiment of the EPOC portion of example EPON-EPOC network 100, described in FIG. 1, or example EPON-EPOC network 200, described above in FIG. 2. As shown in FIG. 3, the EPOC portion includes an EPOC CMC 112 and an EPOC CNU 122, connected via a coaxial network 304.

EPOC CMC 112 includes an optical transceiver 308, a serializer-deserializer (SERDES) module 310, an EPOC PHY module 312, including, in an embodiment, a CMC Interface Field Programmable Gated Array (FPGA) 314 and a Sub-band Division Multiplexing (SDM) FPGA 316, a controller module 318, an analog-to-digital converter (ADC) 322, digital-to-analog converters (DAC) 320, and an radio frequency (RF) module 326, including RF transmit (TX) circuitry 336 and RF receive (RX) circuitry 338.

Optical transceiver 308 may include a digital optical receiver configured to receive an optical signal over a fiber optic cable 302 coupled to CMC 112 and to produce an electrical data signal therefrom. Fiber optic cable 302 may be part of an EPON network that connects CMC 112 to an OLT, such as OLT 102. Optical transceiver 308 may also include a digital optical laser to produce an optical signal from an electrical data signal and to transmit the optical signal over fiber optic cable 302.

SERDES module 310 performs parallel-to-serial and serial-to-parallel conversion of data between optical transceiver 308 and EPOC PHY 312. Electrical data received from optical transceiver 308 is converted from serial to parallel for further processing by EPOC PHY 312. Likewise, electrical data from EPOC PHY 312 is converted from parallel to serial for transmission by optical transceiver 308.

EPOC PHY module 312, optionally with other modules of CMC 112, forms a two-way PHY conversion module. In the downstream direction (i.e., traffic to be transmitted to EPOC CNU 122), EPOC PHY 312 performs PHY level conversion from EPON PHY to coaxial PHY and spectrum shaping of downstream traffic. For example, CMC Interface FPGA 314 may perform line encoding functions, Forward Error Correction (FEC) functions, and framing functions to convert EPON PHY encoded data into coaxial PHY encoded data. SDM FPGA 316 may perform SDM functions, including determining sub-carriers for downstream transmission, determining the width and frequencies of the sub-carriers, selecting the modulation order for downstream transmission, and dividing downstream traffic into multiple streams each for transmission onto a respective sub-carrier of the sub-carriers. In the upstream direction (i.e., traffic received from EPOC CNU 112), EPOC PHY 312 performs traffic assembly and PHY level conversion from coaxial PHY to EPON PHY. For example, SDM FPGA 316 may assemble streams received over multiple sub-carriers to generate a single stream. Then, CMC Interface FPGA 314 may perform line encoding functions, FEC functions, and framing functions to convert coaxial PHY encoded data into EPON PHY encoded data. Detailed description of exemplary implementations and the operation of CMC 112, including functions performed by EPOC PHY 312, can be found in U.S. application Ser. No. 12/878,643, filed Sep. 9, 2010, which is incorporated herein by reference in its entirety.

As would be understood by a person of skill in the art based on the teachings herein, SDM as described above may include any one of transmission technologies that transmit/receiver data onto multiple carriers, including multi-carrier technologies such as Orthogonal Frequency Division Multiplexing (OFDM), wavelet OFDM, Discrete Wavelet Multitone (DWMT), for example, or single-carrier technologies with channel bonding, such as multiple bonded Quadrature Amplitude Modulation (QAM) channels.

Controller module 318 provides software configuration, management, and control of EPOC PHY 312, including CMC Interface FPGA 314 and SDM FPGA 316. In addition, controller module 318 registers CMC 112 with the OLT servicing CMC 112. In an embodiment, controller module 318 is an ONU chip, which includes an EPON MAC module.

DAC 320 and ADC 322 sit in the data path between EPOC PHY 312 and RF module 326, and provide digital-to-analog and analog-to-digital data conversion, respectively, between EPOC PHY 312 and RF module 326.

RF module 326 allows CMC 112 to transmit/receive RF signals over coaxial network 304. In other embodiments, RF module 326 may be external to CMC 112. RF TX circuitry 336 includes an RF transmitter and associated circuitry (e.g., mixers, frequency synthesizer, voltage controlled oscillator (VCO), phase locked loop (PLL), power amplifier (PA), analog filters, matching networks, etc.). RF RX circuitry 338 includes an RF receiver and associated circuitry (e.g., mixers, frequency synthesizer, VCO, PLL, low-noise amplifier (LNA), analog filters, etc.).

EPOC CNU 122 includes RF module 326, including RF TX circuitry 336 and RF RX circuitry 338, DAC 320, ADC 322, an EPOC PHY module 328, including SDM FPGA 316 and a CNU Interface FPGA 330, an EPOC MAC module 332, and a PHY module 334.

RF module 326, DAC 320, ADC 322, and SDM FPGA 316 may be as described above with respect to EPOC CMC 112. Accordingly, their operation in processing downstream traffic (i.e., traffic received from CMC 112) and upstream traffic (i.e., traffic to be transmitted to CMC 112), which should be apparent to a person of skill in the art based on the teachings herein, is omitted.

CNU Interface FPGA 330 provides an interface between SDM FPGA 316 and EPON MAC 332. As such, CNU Interface FPGA 330 may perform coaxial PHY level decoding functions, including line decoding and FEC decoding. EPON MAC module 332 implements an EPON MAC layer, including the ability to receive and process EPON Operation, Administration and Maintenance (OAM) messages, which may be sent by an OLT and forwarded by CMC 112 to CNU 122. In addition, EPON MAC 332 interfaces with a PHY module 334, which may implement an Ethernet PHY layer. PHY module 334 enables physical transmission over a user-network interface (UNI) 306 (e.g., Ethernet cable) to a connected user equipment.

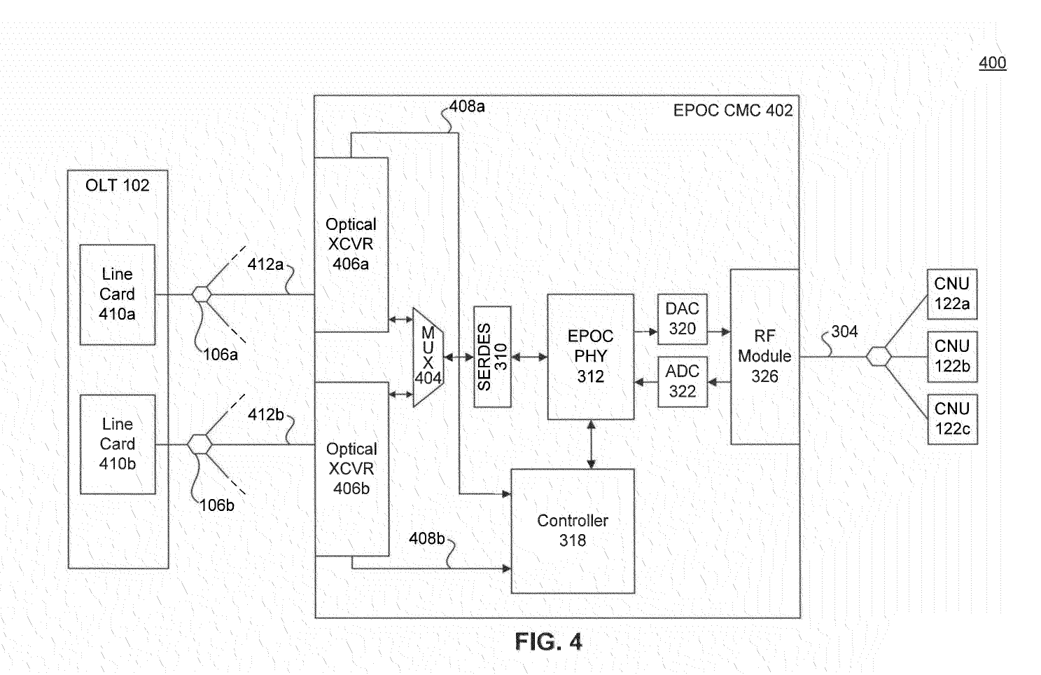

FIG. 4 illustrates an example architecture 400 of a hybrid EPON-EPOC network with EPOC protection switching according to an embodiment of the present disclosure. Example architecture 400 is provided for the purpose of illustration and is not limiting. As shown in FIG. 4, example architecture 400 includes an OLT 102, including a first OLT line card 410a and a second OLT line card 410b; an EPOC CMC 402; and a plurality of CNUs 122a-c.

EPOC CMC 402 is a modified version of EPOC CMC 112 described in FIG. 3 above. Thus, as shown in FIG. 4, EPOC CMC 112 includes similar elements as described above with respect to EPOC CMC 112. In addition, EPOC CMC 402 includes two optical transceivers 406a and 406b and a multiplexer 404. Optical transceiver 406a is configured to couple EPOC CMC 402 to a first fiber link 412a, which is coupled to first OLT line card 410a of OLT 102. Optical transceiver 406b is configured to couple EPOC CMC 402 to a second fiber link 412b, which is coupled to second OLT line card 410b of OLT 102.

Multiplexer 404 is located between first and second optical transceivers 406a and 406b and a data path of EPOC CMC 402 (which includes, for example, SERDES 310, EPOC PHY 312, DAC 320, ADC 322, and RF module 326). In an embodiment, as shown in FIG. 4, multiplexer 404 is located between SERDES module 310 and first and second optical transceivers 406a and 406b. As such, multiplexer 404 allows to selectively couple the data path of EPOC CMC 402 to either optical transceiver 406a or optical transceiver 406b. It is noted that controller 318 may also include multiple SERDES modules, with multiplexers sitting on the parallel interface sides of the SERDES modules.

RF module 326, as described above with respect to FIG. 3, allows EPOC CMC 402 to transmit/receive RF signals over a coaxial network 304. In an embodiment, as shown in example architecture 400, EPOC CMC 402 services CNUs 122a-c via coaxial network 304, to enable end-to-end EPON communication over a hybrid EPON-EPOC network between CNUs 122a-c and OLT 102.

Before data communication begins between a CNU 122 and OLT 102, CNU 122 must register with OLT 102 (as described above, CNU 122 includes an EPON MAC module 332, which enables it to perform this registration). Typically, registration is initiated by OLT 102 (using one of OLT line cards 410a-b) by broadcasting a discovery GATE message with a timestamp of the OLT's local time. When an unregistered CNU 122 (that wishes to join OLT 102) receives the discovery GATE message, it sets its local time to the timestamp in the discovery GATE message and responds by sending a registration request (REGISTER_REQ) message to OLT 102. The registration request message includes the local time of CNU 122 at the time that the registration request message is sent. As such, when it receives the registration request message, OLT 102 can calculate the round-trip time (RTT) between OLT 102 and CNU 122 based on the timestamp in the discovery GATE message and the timestamp in the registration request message. The RTT time includes the round-trip propagation delay plus the processing time at CNU 122.

OLT 102 must perform the registration process for each CNU 122 before any data communication is allowed to take place between OLT 102 and the CNU (this is typically done after CMC 402 performs auto-negotiation and link up with each CNU 122 over coaxial network 304, to ensure PHY symbol alignment between the PHYs, transmit power level configuration, spectrum usage configuration, and modulation order configuration). In particular, determining the RTT for each CNU 122 (which is known as ranging the CNU) is needed to ensure that upstream transmissions from CNUs 122 (which share the same physical medium to reach OLT 102 on a time-division multiplexing (TDM) basis) do not interfere with each other. It is noted that EPOC CMC 402 also must be registered with OLT 102. This may be performed using the same process described above, using, for example, controller module 318 of EPOC CMC 402, which includes an EPON MAC module.

According to embodiments, example architecture 400 may be used to enable protection switching over the EPON portion of the hybrid EPON-EPOC network of FIG. 4. In an embodiment, EPOC CMC 402 may be configured to register itself and to enable CNUs 122 to register with OLT line card 410a, via first fiber link 412a. Registration with OLT line card 410a is as described above and includes ranging each registering unit by OLT line card 410a. Data communication (upstream and downstream) between CNUs 122 and OLT line card 410a may then begin, via EPOC CMC 402, using first fiber link 412a.

Subsequently, if first fiber link 412a is lost for any reason (e.g., first fiber link 412a is cut, disconnected, or experiences signal degradation, OLT line card 410a fails, optical transceiver 406a fails, etc.), EPOC CMC 402 may be configured to register itself and to enable CNUs 122 to register with OLT line card 410b (after each unit de-registers itself with OLT line card 410a), via second fiber link 412b. Registration with OLT line card 410b is as described above and includes re-ranging each registering unit by OLT line card 410b. Re-ranging is required because first fiber link 412 and second fiber link 412b very likely have different lengths between OLT 102 and EPOC CMC 402. Then, data communication (upstream and downstream user traffic) may proceed between CNUs 122 and OLT line card 410b, via EPOC CMC 402, using second fiber link 412b.

Accordingly, second fiber link 412b may be used as a backup link for first fiber link 412a, enabling protection switching over the EPON portion of the hybrid EPON-EPOC network. However, protection switching according to this embodiment may require a relatively large amount of time due to the re-ranging performed by OLT line card 410b. This may result in noticeable service disruption for users of CNUs 122.

In another embodiment, EPOC CMC 402 may be configured to register itself up front with both OLT line card 410a, via first fiber link 412a, and OLT line card 4106, via second fiber link 412b. In an embodiment, EPOC CMC 402 registers itself with OLT line cards 410a-b by responding, using controller 318, to respective discovery GATE messages from OLT line cards 410a-b. This allows OLT line cards 410a and 410b to determine the RTTs on fiber links 412a and 412b, respectively, to EPOC CMC 402. EPOC CMC 402 may then be configured (using controller 318) to enable CNUs 122 to register with OLT line card 410a, via first fiber link 412a. Registration with OLT line card 410a is as described above and includes ranging each registering unit by OLT line card 410a.

Subsequently, at OLT 102, registration information associated with each unit that registered with OLT line card 410a is passed internally from OLT line card 410a to OLT line card 410b. In an embodiment, the registration information associated with a unit includes one or more of: parameters determined during the random discovery phase of registration, parameters determined during the MPCP (Multi-Point Control Protocol) registration phase (e.g., RTT, Logical Link IDs (LLIDs) assigned to the unit, etc.) of registration, parameters determined during the OAM discovery phase (OAM capabilities of the unit) of registration, parameters associated with unicast services at the unit, and parameters associated with multicast groups joined by the unit.

Because EPOC CMC 402 registered with both OLT line card 410a and OLT line card 410b, OLT line card 410b is able to determine the difference between the RTT from OLT line card 410a to CMC 402 and the RTT from OLT line card 410b to CMC 402. Using this difference, OLT line card 410b can determine the RTTs to each of CNUs 122, without requiring CNUs 122 to register directly with it.

Because CNUs 122 do not register directly with OLT line card 410b, OLT line card 410b does not receive reports from CNUs 122 in response to periodical grants that it sends. Normally, OLT line card 410b would de-register a unit if it does not receive any reports from it for a predetermined period of time. To prevent that from happening, in an embodiment, OLT line card 410b includes a standby mode, which allows OLT line card 410b to hold a network unit in a static registration, maintaining any registration information (e.g., provided by OLT line card 410a) and calculated ranging information for the unit without de-registering the unit.

Data communication (upstream and downstream user traffic) between CNUs 122 and OLT line card 410a may then begin, via EPOC CMC 402, using first fiber link 412a. Meanwhile, EPOC CMC 402 may monitor, via controller 318, a status of first fiber link 412a and a status of second fiber link 412b. In an embodiment, controller 318 is configured to receive a first signal detect signal 408a from optical transceiver 406a, providing the status of first fiber link 412a, and a second signal detect signal 408b from optical transceiver 406b, providing the status of second fiber link 412b. Signals 408a and 408b may include, for example, whether an optical signal is detected and/or whether an optical signal of sufficient quality for detection is present on first fiber link 412a and second fiber link 412b, respectively.

Subsequently, if first fiber link 412a is lost for any reason (e.g., first fiber link 412a is cut, disconnected, or experiences signal degradation, OLT line card 410a fails, optical transceiver 406a fails, etc.) as indicated by first signal detect signal 408a, EPOC CMC 402 may be configured to switch the user traffic from first fiber link 412a to second fiber link 412b. In an embodiment. CMC 402 is able to switch the user traffic to second fiber link 412b by responding to a grant from second OLT line card 410b sent over second fiber link 412b.

Because CMC 402 and CNUs 122 are all statically registered with OLT line card 410b, in an embodiment, registration with OLT line card 410b is skipped entirely or partially. Specifically, CMC 402 and CNUs 122 retain the same registration parameters (e.g., LLIDs) obtained during registration by OLT line card 410a. In another embodiment, a number of registration steps (e.g., Random Discovery, MPCP Registration, OAM discovery, etc.) are skipped and only a few registration steps, such as clock synchronization, are performed by each unit before user traffic can be switched to OLT line card 410b. In another embodiment, clock synchronization is performed only by CMC 402 before user traffic can be switched to OLT line card 410b.

While the switching to OLT line card 410b is taking place, controller 318 is configured to enter into a holdover mode. The holdover mode ensures that CMC 402 does not de-register itself (and discards all learned registration parameters) when it determines that first fiber link 412a has been lost. Instead, the holdover mode causes CMC 402 to maintain its current state for a predetermined time, to allow the switching to OLT line card 410b to be completed.

In addition, CMC 402 must ensure that CNUs 122 do not de-register themselves (and discard all learned registration parameters) during the switching. Accordingly, in an embodiment, controller 318 is further configured to continue to transmit clocking information from CMC 402 to CNUs 122 during the holdover mode, thereby maintaining CNUs 122 in the registered status. In another embodiment, CNUs 122 are further configured to detect when a loss of MPCP frames occurs and to go into a holdover mode when that occurs. Once the switch over to the standby OLT line card is completed by CMC 402, CNUs 122 adjust their local MPCP times to a new MPCP time received from the standby OLT. In an further embodiment, the switch over by the CMC to the standby OLT is completed before CNUs 122 detect a loss of MPCP frames. CNUs 122 thus only adjust to the new MPCP time received from the standby OLT.

In another embodiment, controller 318 is configured if it detects that second fiber link 412b to OLT line card 412b (the standby line card) is lost for any reason to inform OLT 102 of the failure on the active link. No switch over is needed in this case, but this helps OLT 102 to proactively maintain the network.

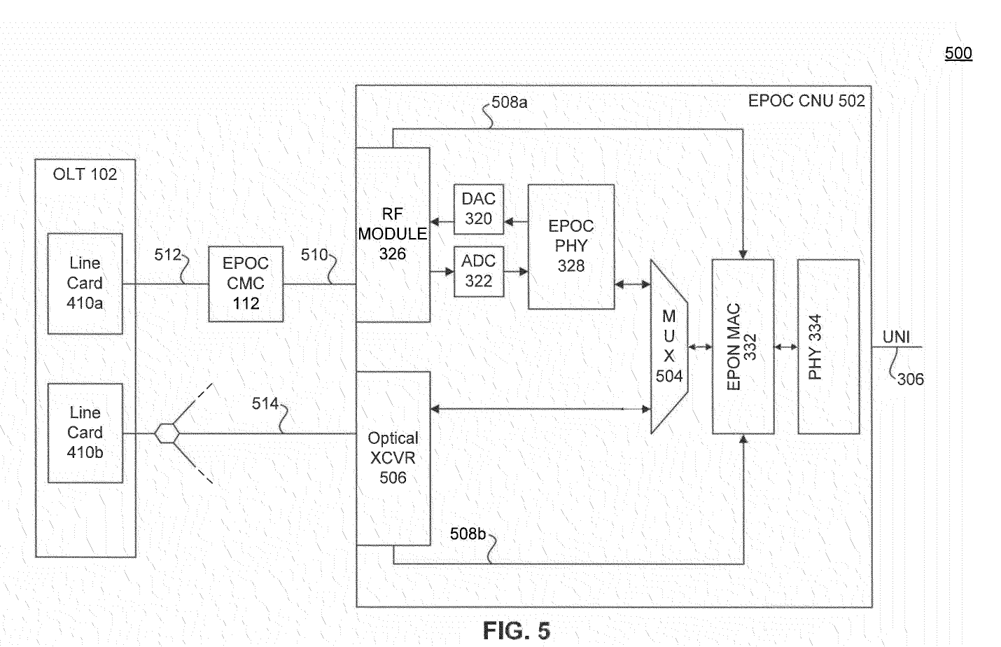

FIG. 5 illustrates another example architecture 500 of a hybrid EPON-EPOC network with EPOC protection switching according to an embodiment of the present disclosure. Example architecture 500 is provided for the purpose of illustration and is not limiting.

As shown in FIG. 5, example architecture 500 includes an OLT 102, including a first OLT line card 410a and a second OLT line card 410b; an EPOC CMC 112; and an EPOC CNU 502. EPOC CNU 502 is a modified version of EPOC CNU 122 described in FIG. 3 above. Thus, as shown in FIG. 5, EPOC CNU 502 includes similar elements as described above with respect to EPOC CNU 122. In addition, EPOC CNU 502 includes an optical transceiver 506 and a multiplexer 504.

In an embodiment, optical transceiver 506 is configured to couple EPOC CNU 502 to a first fiber link 514. First fiber link 514 is coupled to OLT line card 410b of OLT 102. EPOC PHY 328 is configured to couple EPOC CNU 502, via RF module 326, to a coaxial cable 510. Coaxial cable 510 is coupled, via EPOC CMC 112 and a second fiber link 512, to OLT line card 410a of OLT 102. Multiplexer 504 is located between EPOC PHY 328/optical transceiver 506 and EPON MAC module 332. As such, multiplexer 504 allows to selectively couple EPON MAC 332 either to optical transceiver 506, for transmission/reception over first fiber link 514, or EPOC PHY 328, for transmission/reception over coaxial cable 510.

According to embodiments, example architecture 500 may be used to enable protection switching over the EPON portion of the hybrid EPON-EPOC network of FIG. 5. In an embodiment, EPON MAC module 332 may be configured to register EPOC CNU 502 up front with both OLT line card 410b, via first fiber link 514, and OLT line card 410a, via coaxial cable 510, EPOC CMC 112, and second fiber link 512. In an embodiment, EPON MAC module 332 registers EPOC CNU 502 with OLT line cards 410a-b by responding to respective discovery GATE messages from OLT line cards 410a-b. Registration with OLT line cards 410a-b is as described above and includes ranging EPOC CNU 502 by OLT line cards 410a-b, to determine the RTTs to EPOC CNU 502 over the respective paths coupling OLT line cards 410a-b to EPOC CNU 502.

Subsequently, EPOC CNU 502 may select one of OLT line cards 410a-b as an active OLT line card and the other as a standby OLT tine card. For example, in an embodiment, EPOC CNU 502 may select OLT line card 410b as the active OLT line card and OLT line card 410a as the standby OLT line card. In another embodiment, EPOC CNU 502 may make the reverse selection. Data communication (upstream and downstream) between EPOC CNU 502 and the active OLT line card may then begin. In an embodiment, EPOC CNU 502 may communicate control traffic (e.g., MPCP or OAM messages) periodically with the standby OLT line card to remain registered with the standby OLT line card.

While data communicating with the active OLT line card, EPOC CNU 502 may monitor, via EPON MAC module 332, a status of first fiber link 514 and a status of coaxial cable 510. In an embodiment, EPON MAC module 332 is configured to receive a first signal detect signal 508b from optical transceiver 506, providing the status of first fiber link 514, and a second signal detect signal 508a from RF module 326, providing the status of coaxial cable 510. In another embodiment, signal detect signal 508a is replaced by having RF module 326 provide an interrupt indicating link status change (e.g., link up/down) to EPON MAC module 332, i.e., no wire is routed from RF module 326 to EPON MAC 332. Signal 508a (508b) may include, for example, whether a pilot tone (optical) signal is detected and/or whether an RF (optical) signal of sufficient quality for demodulation (detection) is present on coaxial cable 510 (first fiber link 514).

Subsequently, if the link to the active OLT line card is lost for any reason (e.g., link is cut, disconnected, or experiences signal degradation, the active OLT line card fails, EPOC CMC 112 fails, optical transceiver 506 or RF module 326 fails, etc.) as indicated by first signal detect signal 508a (when OLT line card 410a is the active OLT line card) or second signal detect signal 508b (when OLT line card 410b is the active OLT line card), EPOC CNU 502, via EPON MAC module 332 and multiplexer 504, may be configured to switch the user traffic from the active OLT line card to the standby OLT line card. In an embodiment, EPON MAC module 332 is able to switch the user traffic to the standby OLT line card by responding to a grant from the standby OLT line card. Because EPOC CNU 502 is already registered with the standby OLT line card, no other or minimal steps are needed before EPOC CNU 502 may switch the user traffic to the standby OLT line card.

In an embodiment, EPOC CNU 502 selects OLT line card 410b as the active OLT line card and OLT line card 410a as the standby OLT line card. Subsequently, if first fiber link 514 is lost, multiplexer 504 is controlled by EPON MAC 332 to couple EPON MAC 332 to EPOC PHY 328, in order to switch user traffic from first fiber link 514 to coaxial cable 510. In an embodiment, in order to enable fast switching over to coaxial cable 510, EPOC PHY 328 is configured to maintain the link over coaxial cable 510 in a cold or warm standby mode. In the cold standby mode, only CMC-CNU PHY clock synchronization is needed before the link can be used. In the warm standby mode, the PHY link is ready to use immediately.

In another embodiment, EPOC CNU 502 selects OLT line card 410a as the active OLT line card and OLT line card 410b as the standby OLT line card. Subsequently, if the link over coaxial cable 510 is lost, multiplexer 504 is controlled by EPON MAC 332 to couple EPON MAC 332 to optical transceiver 506, in order to switch user traffic from coaxial cable 510 to first fiber link 514. OLT line card 410b maintains EPOC CNU 502 statically registered (maintaining its LLIDs in standby mode), even though it does not receive any reports back from EPOC CNU 502 in response to polling grants that it sends. Once the switch over occurs, CNU 502 adjusts its MPCP time based on a subsequent GATE message it receives from OLT line card 410b, and then responds to OLT line card 410b in one of the polling grants sent by OLT line card 410b. Upon hearing from CNU 502, OLT line card 410b puts the LLIDs associated with CNU 502 in active registration state. Accordingly, in this embodiment, fiber link 514 is maintained in a warm standby mode, because only MPCP time adjustment at the MAC layer is needed before the link can be used for user traffic.

In another embodiment, EPON MAC 332 is configured if it detects that the standby link is lost for any reason to inform OLT 102 of the failure on the active link. No switch over is needed in this case, but this helps OLT 102 to proactively maintain the network.

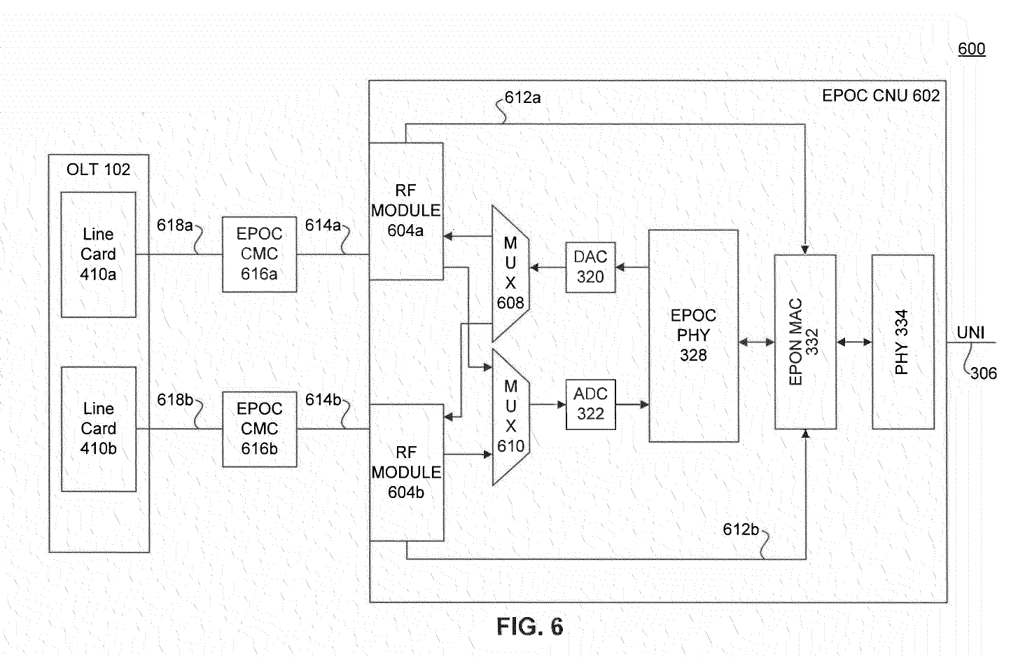

FIG. 6 illustrates another example architecture 600 of a hybrid EPON-EPOC network with EPOC protection switching according to an embodiment of the present disclosure. Example architecture 600 is provided for the purpose of illustration and is not limiting.

As shown in FIG. 6, example architecture 600 includes an OLT 102, including a first OLT line card 410a and a second OLT line card 410b; first and second EPOC CMCs 616a and 616b; and an EPOC CNU 602. EPOC CMCs 616a and 616b may be similar to EPOC CMC 112 described above in FIG. 3. EPOC CNU 602 is a modified version of EPOC CNU 122 described in FIG. 3 above. Specifically, in addition to having similar elements as EPOC CNU 122, EPOC CNU 602 includes two RF modules 604a and 604b, a transmit multiplexer 608, and a receive multiplexer 610.

In an embodiment, RF module 604a is configured to couple EPOC CNU 602 to a first coaxial cable 614a. First coaxial cable 614a is coupled, via first EPOC CMC 616a and a first fiber link 618a, to OLT line card 410a of OLT 102. RF module 604b is configured to couple EPOC CNU 602 to a second coaxial cable 614b. Second coaxial cable 614b is coupled, via second EPOC CMC 616b and a second fiber link 618b, to OLT line card 410b of OLT 102.

Transmit multiplexer 608 is located between DAC 320 and RF modules 604a-b. As such, multiplexer 608 allows to selectively couple an output of DAC 320 either to RF module 604a, for transmission over first coaxial cable 614a, or to RF module 604b, for transmission over coaxial cable 614b. Receive multiplexer 610 is located between ADC 322 and RF modules 604a-b. As such, multiplexer 610 allows to selectively couple an input of ADC 322 either to RF module 604a, for reception over first coaxial cable 614a, or to RF module 604b, for reception over coaxial cable 614b.

According to embodiments, example architecture 600 may be used to enable protection switching over the EPON and/or EPOC portion of the hybrid EPON-EPOC network of FIG. 6. In an embodiment, EPON MAC module 332 may be configured to register EPOC CNU 602 up front with both OLT line card 410a (via coaxial cable 614a, CMC 616a, and first fiber link 618a), and OLT line card 410b (via coaxial cable 614b, CMC 616b, and first fiber link 618b). In an embodiment, EPON MAC module 332 registers EPOC CNU 602 with OLT line cards 410a-b by responding to respective discovery GATE messages from OLT line cards 410a-b. Registration with OLT line cards 410a-b is as described above and includes ranging EPOC CNU 602 by OLT line cards 410a-b, to determine the RTTs to EPOC CNU 602 over the respective paths coupling OLT line cards 410a-b to EPOC CNU 602.

Subsequently, EPOC CNU 602 may select one of OLT line cards 410a-b as an active OLT line card and the other as a standby OLT line card. For example, in an embodiment. EPOC CNU 602 may select OLT line card 410a as the active OLT line card and OLT line card 410b as the standby OLT line card. In another embodiment, EPOC CNU 602 may make the reverse selection. Data communication (upstream and downstream) between EPOC CNU 602 and the active OLT line card may then begin. In an embodiment, EPOC CNU 602 may communicate control traffic (e.g., MPCP or OAM messages) periodically with the standby OLT line card to remain registered with the standby OLT line card.

While data communicating with the active OLT line card, EPOC CNU 602 may monitor, via EPON MAC module 332, a status of first coaxial cable 614a and a status of second coaxial cable 614b. In an embodiment, EPON MAC module 332 is configured to receive a first signal detect signal 612a from RF module 604a, providing the status of first coaxial cable 614a, and a second signal detect signal 612b from RF module 604b, providing the status of coaxial cable 614b. Signals 612a-b may include, for example, whether an electrical signal is detected and/or whether an electrical signal of sufficient quality for demodulation is present on coaxial cables 614a-b, respectively.

Subsequently, if the link to the active OLT line card is lost for any reason (e.g., link is cut at any point, disconnected, or experiences signal degradation, the active OLT line card fails, EPOC CMC 616a/616b fails, RF module 604a/604b fails, etc.) as indicated by first signal detect signal 612a (when OLT line card 410a is the active OLT line card) or second signal detect signal 612b (when OLT line card 410b is the active OLT line card), EPOC CNU 602, via EPON MAC module 332 and multiplexers 608 and 610, may be configured to switch the user traffic from the active OLT line card to the standby OLT line card. In an embodiment, EPON MAC module 332 is able to switch the user traffic to the standby OLT line card by responding to a grant from the standby OLT line card. Because EPOC CNU 602 is already registered with the standby OLT line card, no other steps or only minimal steps are needed before EPOC CNU 602 may switch the user traffic to the standby OLT line card.

In an embodiment, EPOC CNU 602 selects OLT line card 410a as the active OLT line card and OLT line card 410b as the standby OLT line card. Subsequently, if the link to OLT line card 410a is lost (e.g., OLT line card 410, EPOC CMC 616a, and/or RF module 604a fails, fiber line 618a and/or coaxial cable 614a is cut or disconnected, etc.), multiplexers 608 and 610 are controlled to couple DAC 320 and ADC 322, respectively, to RF module 604b, in order to switch user traffic from first coaxial cable 614a to second coaxial cable 614b. In an embodiment, in order to enable fast switching over to coaxial cable 614b, EPOC PHY 328 is configured to maintain the link over coaxial cable 614b in a warm standby mode. In the warm standby mode, the PHY link is ready to use and only MPCP time adjustment is needed at the MAC layer for the switchover.

In another embodiment, EPON MAC 332 is configured if it detects that the standby link is lost for any reason to inform OLT 102 of the failure on the active link. No switch over is needed in this case, but this helps OLT 102 to proactively maintain the network.

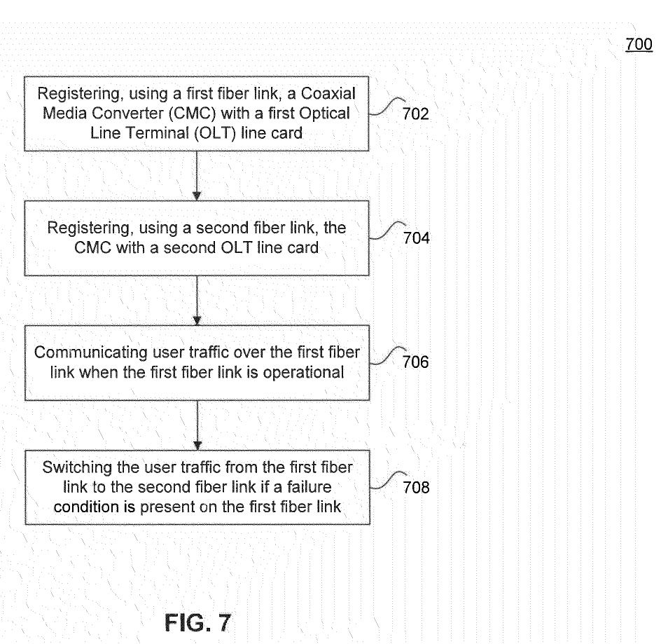

FIG. 7 is a process flowchart 700 of a method for providing protection switching in an EPOC according to an embodiment of the present disclosure. Process 700 is provided for the purpose of illustration and is not limiting. In an embodiment, process 700 may be performed by a coaxial media converter; such as EPOC CMC 402, for example.

As shown in FIG. 7, process 700 begins in step 702, which includes registering, using a first fiber link, a CMC with a first OLT line card. In an embodiment, the first OLT line card is coupled to the CMC via the first fiber link. Then, in step 704, process 700 includes registering, using a second fiber link, the CMC with a second OLT line card. In an embodiment, the second OLT line card is coupled to the CMC via the second fiber link.

Subsequently, process 700 proceeds to step 706, which includes communicating user traffic over the first fiber link when the first fiber link is operational. In an embodiment, step 706 further includes monitoring a status of the first fiber link and a status of the second fiber link during step 706. In embodiment, the monitoring includes receiving a first signal detect signal from a first optical transceiver coupled to the first fiber link, which provides the status of the first fiber link; and receiving a second signal detect signal from a second optical transceiver coupled to the second fiber link, which provides the status of the second fiber link.

Subsequently, if a failure condition is detected on the first fiber link, process 700 includes, in step 708, switching the user traffic from the first fiber link to the second fiber link. In an embodiment, step 708 further includes responding to a grant from the second OLT line card to switch the user traffic from the first fiber link to the second fiber link. In an embodiment, step 708 further includes entering a holdover mode at the CMC, where in the holdover mode the CMC is maintained in a registered status despite the loss of the first fiber link. Further, the holdover mode may include transmitting clocking information from the CMC to at least one coaxial network unit (CNU) serviced by the CMC, thereby maintaining the CNU in the registered status.

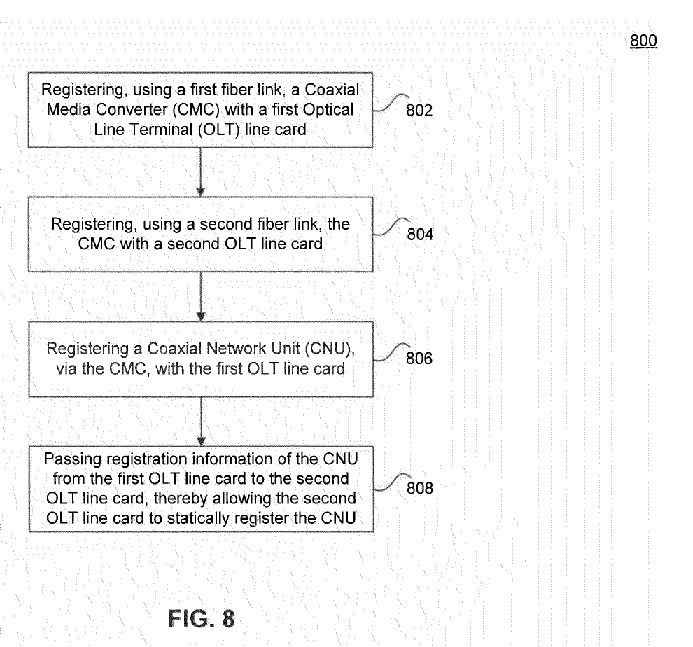

FIG. 8 is a process flowchart 800 of a method for providing protection switching in an EPOC according to an embodiment of the present disclosure. Process 800 is provided for the purpose of illustration and is not limiting. In an embodiment, process 800 may be performed by a coaxial media converter, such as EPOC CMC 402, for example, and/or an optical line terminal, such as OLT 102.

As show in FIG. 8, process 800 begins in step 802, which includes registering, using a first fiber link, a CMC with a first OLT line card. In an embodiment, the first OLT line card is coupled to the CMC via the first fiber link. Then, in step 804, process 800 includes registering, using a second fiber link, the CMC with a second OLT line card. In an embodiment, the second OLT line card is coupled to the CMC via the second fiber link. The first and second OLT line cards may be located in the same or in different OLTs.

Subsequently, process 800 proceeds to step 806, which includes registering a coaxial network unit (CNU), via the CMC, with the first OLT line card. Then, in step 808, process 800 includes passing registration information of the CNU from the first OLT line card to the second OLT line card, thereby allowing the second OLT line card to statically register the CNU. In an embodiment, step 808 further includes providing a standby mode whereby the CNU is held statically registered by the second OLT line card.

It will be apparent to persons skilled in the relevant art(s) that various elements and features of the present disclosure, as described herein, can be implemented in hardware using analog and/or digital circuits, in software, through the execution of instructions by one or more general purpose or special-purpose processors, or as a combination of hardware and software.

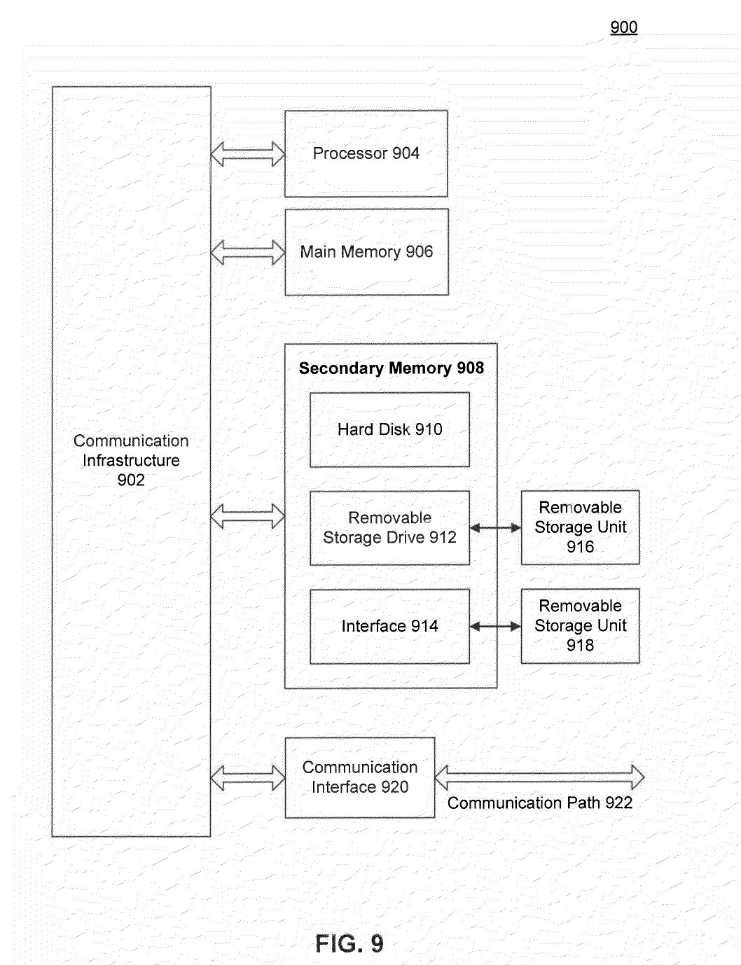

The following description of a general purpose computer system is provided for the sake of completeness. Embodiments of the present disclosure can be implemented in hardware, or as a combination of software and hardware. Consequently, embodiments of the disclosure may be implemented in the environment of a computer system or other processing system. An example of such a computer system 900 is shown in FIG. 9. Modules depicted in FIGS. 3-6 may execute on one or more computer systems 900. Furthermore, each of the steps of the flowcharts depicted in FIGS. 7-8 can be implemented on one or more computer systems 900.

Computer system 900 includes one or more processors, such as processor 904. Processor 904 can be a special purpose or a general purpose digital signal processor. Processor 904 is connected to a communication infrastructure 902 (for example, a bus or network). Various software implementations are described in terms of this exemplary computer system. After reading this description, it will become apparent to a person skilled in the relevant art(s) how to implement the disclosure using other computer systems and/or computer architectures.

Computer system 900 also includes a main memory 906, preferably random access memory (RAM), and may also include a secondary memory 908. Secondary memory 908 may include, for example, a hard disk drive 910 and/or a removable storage drive 912, representing a floppy disk drive, a magnetic tape drive, an optical disk drive, or the like. Removable storage drive 912 reads from and/or writes to a removable storage unit 916 in a well-known manner. Removable storage unit 916 represents a floppy disk, magnetic tape, optical disk, or the like, which is read by and written to by removable storage drive 912. As will be appreciated by persons skilled in the relevant art(s), removable storage unit 916 includes a computer usable storage medium having stored therein computer software and/or data.

In alternative implementations, secondary memory 908 may include other similar means for allowing computer programs or other instructions to be loaded into computer system 900. Such means may include, for example, a removable storage unit 918 and an interface 914. Examples of such means may include a program cartridge and cartridge interface (such as that found in video game devices), a removable memory chip (such as an EPROM, or PROM) and associated socket, a thumb drive and USB port, and other removable storage units 918 and interfaces 914 which allow software and data to be transferred from removable storage unit 918 to computer system 900.

Computer system 900 may also include a communications interface 920. Communications interface 920 allows software and data to be transferred between computer system 900 and external devices. Examples of communications interface 920 may include a modem, a network interface (such as an Ethernet card), a communications port, a PCMCIA slot and card, etc. Software and data transferred via communications interface 920 are in the form of signals which may be electronic, electromagnetic, optical, or other signals capable of being received by communications interface 920. These signals are provided to communications interface 920 via a communications path 922. Communications path 922 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 916 and 918 or a hard disk installed in hard disk drive 910. These computer program products are means for providing software to computer system 900.

Computer programs (also called computer control logic) are stored in main memory 906 and/or secondary memory 908. Computer programs may also be received via communications interface 920. Such computer programs, when executed, enable the computer system 900 to implement the present disclosure as discussed herein. In particular, the computer programs, when executed, enable processor 904 to implement the processes of the present disclosure, such as any of the methods described herein. Accordingly, such computer programs represent controllers of the computer system 900. Where the disclosure is implemented using software, the software may be stored in a computer program product and loaded into computer system 900 using removable storage drive 912, interface 914, or communications interface 920.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### CONCLUSION

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the present disclosure should not be limited by any of the above-described exemplary embodiments, but should be defined only in accordance with the following claims and their equivalents.

What is claimed is:

1. A Coaxial Media Converter (CMC), comprising:
a first optical transceiver configured to couple the CMC to a first fiber link, the first fiber link coupled to a first Optical Line Terminal (OLT) line card;
a second optical transceiver configured to couple the CMC to a second fiber link, the second fiber link coupled to a second OLT line card; and
a controller configured to register the CMC, using the first fiber link, with the first OLT line card and to register the CMC, using the second fiber link, with the second OLT line card,
the controller further configured to communicate user traffic over the first fiber link when the first fiber link is operational, and to switch the user traffic from the first fiber link to the second fiber link when a failure condition is present on the first fiber link.

2. The CMC of claim 1, wherein the controller is further configured to respond to a first discovery GATE message from the first OLT line card to register the CMC with the first OLT line card and to respond to a second discovery GATE message from the second OLT line card to register the CMC with the second OLT line card.

3. The CMC of claim 2, wherein the controller, by registering the CMC with the first OLT line card, enables the first OLT line card to determine a first round-trip time (RTT) to the CMC and, by registering the CMC with second OLT line card, enables the second OLT line card to determine a second RTT to the CMC.

4. The CMC of claim 1, wherein the CMC is configured to service at least one Coaxial Network Unit (CNU), and wherein the controller is further configured to enable the at least one CNU to register, using the first fiber link, with the first OLT line card.

5. The CMC of claim 4, wherein the CMC is configured to enable the at least one CNU to statically register with the second OLT line card.

6. The CMC of claim 1, wherein the controller is further configured to monitor a status of the first fiber link and a status of the second fiber link.

7. The CMC of claim 6, wherein the controller is further configured to receive a first signal detect signal from the first optical transceiver, the first signal detect signal providing the status of the first fiber link, and a second signal detect signal from the second optical transceiver, the second signal detect signal providing the status of the second fiber link.

8. The CMC of claim 6, wherein the status of the first fiber link indicates the failure condition, and wherein the controller is configured to enter a holdover mode, wherein in the holdover mode the CMC is maintained in a registered status.

9. The CMC of claim 8, wherein in the holdover mode, the controller is further configured to transmit clocking information from the CMC to at least one coaxial network unit (CNU) serviced by the CMC, thereby maintaining the CNU in the registered status.

10. The CMC of claim 1, wherein the controller is configured to respond to a grant from the second OLT line card to switch over the user traffic from the first OLT line card to the second OLT line card when the failure condition is present on the first fiber link.

11. A method for providing protection switching in an Ethernet Passive Optical Network over Coaxial (EPOC) network, comprising:
registering, using a first fiber link, a Coaxial Media Converter (CMC) with a first Optical Line Terminal (OLT) line card, the first OLT line card coupled to the CMC via the first fiber link;
registering, using a second fiber link, the CMC with a second OLT line card, the second OLT line card coupled to the CMC via the second fiber link;
communicating user traffic over the first fiber link when the first fiber link is operational; and
switching the user traffic from the first fiber link to the second fiber link when a failure condition is present on the first fiber link.

12. The method of claim 11, wherein registering the CMC with the first OLT line card comprises responding to a first discovery GATE message from the first OLT line card, and wherein registering the CMC with the second OLT line card comprises responding to a second discovery GATE message from the second OLT line card.

13. The method of claim 11, wherein the CMC is configured to service at least one Coaxial Network Unit (CNU), further comprising:
registering the at least one CNU, using the first fiber link, with the first OLT line card; and
registering the least one CNU statically with the second OLT line card.

14. The method of claim 11, further comprising monitoring a status of the first fiber link and a status of the second fiber link.

15. The method of claim 14, further comprising:
receiving a first signal detect signal from a first optical transceiver coupled to the first fiber link, the first signal detect signal providing the status of the first fiber link, and
receiving a second signal detect signal from a second optical transceiver coupled to the second fiber link, the second signal detect signal providing the status of the second fiber link.

16. The method of claim 14, wherein the status of the first fiber link indicates the failure condition, further comprising:
entering a holdover mode at the CMC, wherein in the holdover mode the CMC is maintained in a registered status.

17. The method of claim 16, further comprising:
in the holdover mode, transmitting clocking information from the CMC to at least one coaxial network unit (CNU) serviced by the CMC, thereby maintaining the CNU in the registered status.

18. The method of claim 14, wherein the status of the second fiber link indicates a loss of the second fiber link, further comprising:
sending an alarm message to the first OLT line card over the first fiber link regarding the loss of the second fiber link.

19. The method of claim 11, wherein switching the user traffic from the first fiber link to the second fiber link comprises responding to a grant from the second OLT line card when the failure condition is present on the first fiber link.

20. A network unit, comprising:
an optical transceiver configured to couple the network unit to a first fiber link, the first fiber link coupled to a first Optical Line Terminal (OLT) line card;
a coaxial physical layer (PHY) chip configured to couple the network unit to a coaxial cable, the coaxial cable coupled to a second OLT line card via a Coaxial Media Converter (CMC) and a second fiber link;
an Ethernet Passive Optical Network (EPON) Medium Access Control (MAC) chip configured to register the network unit, using the first fiber link, with the first OLT line card and to register the network unit, using the coaxial cable, CMC, and second fiber link, with the second OLT line card; and
a multiplexer configured to selectively couple the EPON MAC chip to the optical transceiver or to the coaxial PHY chip,
wherein the multiplexer is further configured to couple the EPON MAC chip to the optical transceiver when the first fiber link is operational, and to couple the EPON MAC chip to the coaxial PHY chip when a failure condition is present on the first fiber link.

21. The network unit of claim 20, wherein the coaxial PRY chip is further configured to maintain a link over the coaxial cable between the network unit and the CMC in a warm standby mode, when the first fiber link is operational.
